(19) United States
(12) Patent Application Publication
(10) Pub. No.: US 2014/0348485 A1
(43) Pub. Date: Nov. 27, 2014

(54) IMAGE SIGNAL PROCESSING APPARATUS AND IMAGE SIGNAL PROCESSING METHOD

(71) Applicant: Kabushiki Kaisha Toshiba, Tokyo (JP)

(72) Inventor: Masanori Fujiwara, Gyoda Saitama (JP)

(21) Appl. No.: 14/454,573

(22) Filed: Aug. 7, 2014

Related U.S. Application Data
(63) Continuation of application No. PCT/JP2013/063931, filed on May 20, 2013.

(51) Int. Cl. H04N 21/44; H04N 5/775; H04N 9/87; H04N 21/436; H04N 21/4363

(52) U.S. Cl. CPC H04N 21/44008; H04N 21/43622; H04N 21/43635; H04N 21/43637; H04N 9/87; H04N 5/775
USPC 386/231; 386/353

(57) ABSTRACT

According to one embodiments, a user can selectively view any kind of images in a desired size without any troublesome operation. An apparatus has an input terminal. A first image signal of a first standard and a second image signal of a second standard are compatibly input to the input terminal. If the apparatus determines that the input image signal is a signal based on the first standard, a signal processing accordance with the first standard is employed, and an image signal is generated to be displayed in the first display mode. If the apparatus determines that the input image signal is a signal based on the second standard, a signal processing accordance with the second standard is employed, and an image signal is generated to be displayed in the second display mode.

### CROSS REFERENCE TO RELATED APPLICATIONS

This application is a Continuation Application of PCT Application No. PCT/JP2013/063931, filed May 20, 2013, the entire contents of all of which are incorporated herein by reference.

### FIELD

Embodiments described herein relate generally to an image signal processing apparatus to which a plurality of image input sources are input and which generates an image signal corresponding to each image input source for display, and an image signal processing method for the same.

### BACKGROUND

An image signal processing apparatus to which a plurality of image input sources classified according to presence/absence of black band and caption and the like in an image and which generates an image signal corresponding to each image input source for display has been well known.

However, in such a conventional image signal processing apparatus, there are a first image signal (HDMI signal) of a first standard (for example, HDMI) from an imaging apparatus (DVD recorder and HDD recorder, etc.) and a second image signal (MHL signal) of a second standard from a smartphone, and a user cannot view an image of the first image signal or of the second image signal in a desired image size unless certain effort for image size conversion.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows a principle signal processing system of a digital television broadcast receiver 111.

FIG. 2 shows feature parts of present embodiments.

FIG. 3 shows display images of each display mode.

FIG. 4 shows display images of each display mode.

FIG. 5 shows an example of a setting menu, respectively.

FIG. 6 shows an example of a setting menu.

### DETAILED DESCRIPTION

Hereinafter, present embodiments are explained.

In general, according to one embodiment, there are provided an image signal processing apparatus including an input terminal to which a first image signal of a first standard and a second image signal of a second standard are compatibly input, the input terminal being in accordance with the first standard, a display mode storage module configured to store a first display mode used when the first image signal is input to the input terminal and a second display mode used when the second image signal is input to the input terminal, a detection module configured to determine whether the image signal input to the input terminal is of the first image signal or the second image signal, and an image signal output module configured to generate, if the detection module determines that the first image signal is input to the input terminal, an image signal to be displayed in the first display mode by generating image data using signal processing in accordance with the first standard, and to generate, if the detection module determines that the second image signal is input to the input terminal, an image signal to be displayed in the second display mode by generating image data using signal processing in accordance with the second standard, and the image signal output module configured to output the generated image signal.

Note that, according to the embodiments, the apparatus invention is also achievable as a method invention, and the method invention is also achievable as an apparatus invention.

The apparatus and method inventions are achievable as a program used in a computer to execute steps corresponding to the inventions (or a program to functionalize the computer as means corresponding to the inventions, or a program to have the computer to achieve the functions corresponding to the inventions), and are achievable as a computer-readable recording medium storing such a program.

Note that the image signal processing apparatus of the present embodiments may be an image signal processing apparatus compatible with both image signals of high-definition multimedia interface (HDMI) and mobile high-definition link (MHL), and may be an image signal display monitor, digital television broadcast receiver, hard disk recorder, and set-top box. Hereinafter, the image signal processing apparatus of the present embodiments is, by way of example, described as a digital television broadcast receiver.

Hereinafter, present embodiments are further explained with reference to the drawings in detail.

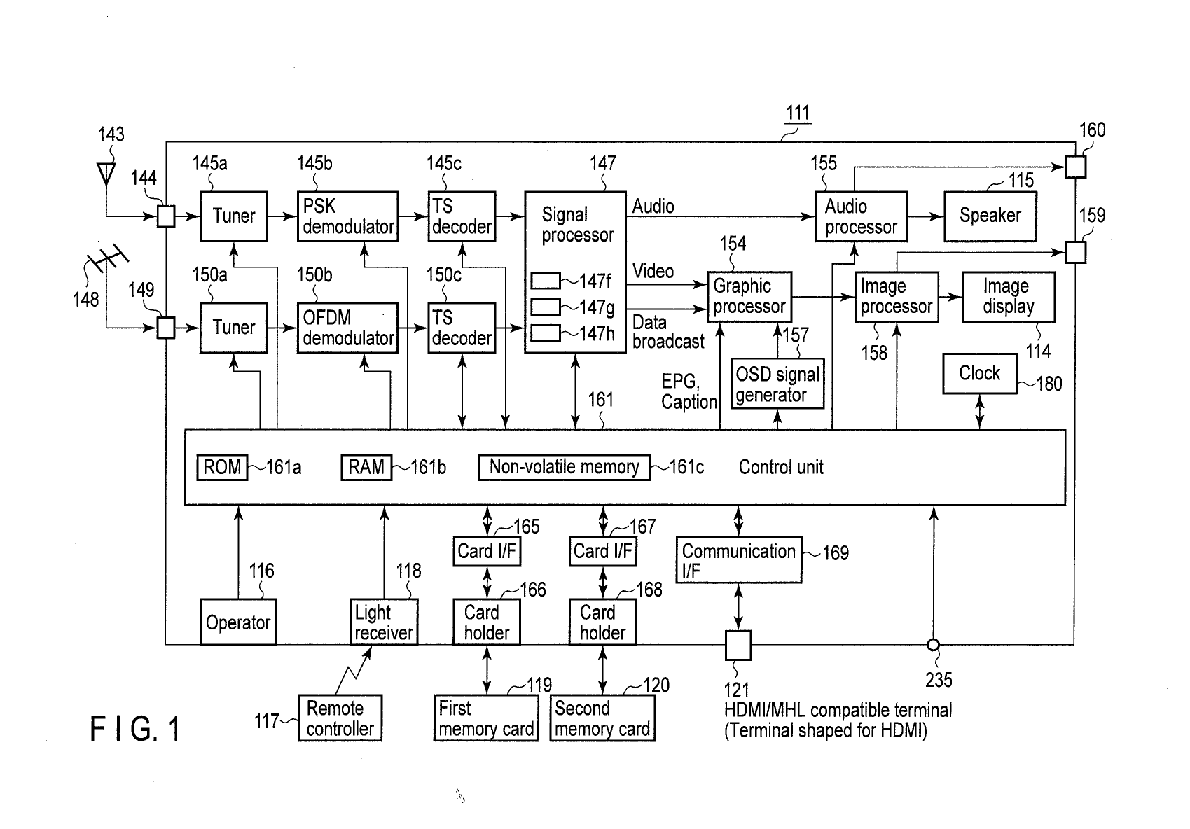

FIG. 1 shows a principle signal processing system of a digital television broadcast receiver 111.

A satellite digital television broadcast signal received at an antenna 143 for BS/CS digital broadcast reception is supplied to a tuner 145a for satellite digital broadcast through an input terminal 144.

The tuner 145a selects a broadcast signal of a desired channel based on a control signal from a control unit 161, and outputs the broadcast signal of the selected channel to a phase shift keying (PSK) demodulator 145b.

The PSK demodulator 145b demodulates the broadcast signal selected in the tuner 145a based on the control signal from the control unit 161, obtains a transport stream (TS) including the desired program, and outputs the transport stream to a TS decoder 145c.

The decoder 145c performs TS decoding of TS multiplex signal based on the control signal from the control unit 161, performs depacketization of digital image signal and digital audio signal of the desired program to obtain a packetized elementary stream (PES), and outputs the PES to an STD buffer 147f in a signal processor 147.

Furthermore, the TS decoder 145c outputs section information sent in a digital broadcast to a section processor 147h in the signal processor 147.

Furthermore, a terrestrial digital television broadcast signal received at an antenna 148 for terrestrial broadcast reception is supplied to a tuner 150a through an input terminal 149 for terrestrial digital broadcast.

The tuner 150a selects a broadcast signal of a desired channel based on a control signal from a control unit 161, and outputs the broadcast signal of the selected channel to an orthogonal frequency division multiplexing (OFDM) demodulator 150b.

The OFDM demodulator 150b demodulates the broadcast signal selected in the tuner 150a based on the control signal from the control unit 161, obtains a transport stream (TS) including the desired program, and outputs the transport stream to a TS decoder 150c.

The decoder 150c performs TS decoding of TS multiplex signal based on the control signal from the control unit 161, performs depacketization of digital image signal and digital audio signal of the desired program to obtain a packetized elementary stream (PES), and outputs the PES to the STD buffer 147f in the signal processor 147.

Furthermore, the TS decoder 150c outputs section information sent in a digital broadcast to the section processor 147h in the signal processor 147.

Here, the signal processor 147 selectively applies predetermined digital signal processing to the digital image signal and digital audio signal supplied from the TS decoder 145c and the TS decoder 150c when the television broadcast is viewed, and outputs the processed digital image signal and digital audio signal to a graphic processor 154 and an audio processor 155, respectively.

The digital television broadcast receiver 111 comprises an HDMI/MHL compatible terminal 121. The shape of HDMI/MHL compatible terminal 121 is the same as that of HDMI terminal. To process an HDMI signal or a MHL signal input from the HDMI/MHL compatible terminal 121, the signal processor 147 applies predetermined digital signal processing to the HDMI signal or the MHL signal from the control unit 161 to generate an image signal for display and outputs the image signal for display to the graphic processor 154 and the audio processor 155.

A terminal 235 receives vertical position information for display mode 9 (described below) and supplies the information to the control unit 161.

The control unit 161 receives and stores various data to acquire a program, electronic program guide (EPG) information, program attribute information (indicative of a program genre and the like), and caption information (service information, SI, and PSI), etc. which are input by the signal processor 147.

The control unit 161 performs an image generation process to display the EPG and the caption based on the input information and data, and outputs the generated image information to the graphic processor 154.

The section processor 147h selects, from section information input by the TS decoder 145c (150c), various data to acquire a program, electronic program guide (EPG) information, program attribute information (indicative of a program genre and the like), and caption information (service information, SI, and PSI), etc., and outputs them to the control unit 161.

The graphic processor 154 synthesize: (1) digital image signal supplied from an AV decoder 147g in the signal processor 147; (2) OSD signal generated in an on-screen display (OSD) signal generator 157; (3) image data of data broadcast; and (4) EPG and caption signal generated by the control unit 161, and outputs them to an image processor 158.

Furthermore, when a caption is displayed in a captioned broadcast, the graphic processor 154 superposes caption information on the image signal based on the caption information controlled by the control unit 161.

The digital image signal output from the graphic processor 154 is input in the image processor 158. The image processor 158 converts the input digital image signal into an analog image signal which is a format displayable in an image display 114, and outputs the analog image signal to the image display 114 and to an external device through an output terminal 159.

Furthermore, the audio processor 155 converts the input digital audio signal into an analog audio signal which is a format playable by a speaker 115, and outputs the analog audio signal to the speaker 115 for audio play and to an external device through an output terminal 160.

Here, the entire functions including the above-described various reception functions of the digital television broadcast receiver 111 are controlled by the control unit 161. The control unit 161 includes a central processing unit (CPU) and the like, receives operation information from an operation unit 116 or operation information sent from a remote controller 117 at a light receiver 118, and controls each part of the digital television broadcast receiver 111 to reflect an operation instruction thereupon.

In that case, the control unit 161 mainly uses a read-only memory (ROM) 161a storing control programs to be executed by the CPU, random-access memory (RAM) 161b providing a work area for the CPU, and non-volatile memory 161c storing various setting and control information, etc.

Furthermore, the control unit 161 is connected to a card holder 166 on which a first memory card 119 is mountable through a card I/F (interface) 165. Through the card I/F 165, the control unit 161 can receive/transfer information from/to the first memory card 119 mounted on the card holder 166.

Furthermore, the control unit 161 is connected to a card holder 168 on which a second memory card 120 is mountable through a card I/F 167. Through the card I/F 167, the control unit 161 can receive/transfer information from/to the second memory card 120 mounted on the card holder 168.

In these days, connection between a television receiver and an image device or a smartphone is made mainly based on a digital transmission method. A high-definition multimedia interface (HDMI) is used in the connection between the television receiver and the image device (such as DVD recorder and HDD recorder). A mobile high-definition link (MHL) method is used in the connection between the television receiver and the smartphone.

Currently, if an image from a MHL compatible smartphone is displayed on a television receiver, a MHL signal output from a microUSB terminal is firstly converted into an HDMI standard signal by an MHL-HDMI conversion adopter, and then is supplied to the television receiver in most cases. The television receiver then processes the input HDMI standard signal to display the image from the smartphone.

Recently, some of the digital television broadcast receivers include an HDMI/MHL compatible terminal 121 by which both HDMI and MHL can be used compatibly. The HDMI/MHL compatible terminal 121 has a physical shape conforming to the HDMI standard to receive an input of the HDMI standard signal from the image device (such as DVD recorder and HDD recorder), and the HDMI/MHL compatible terminal 121 receives an MHL signal from the MHL compatible smartphone through an MHL compatible cable (whose display-side terminal end has a physical shape conforming to HDMI). As a television including such an HDMI/MHL compatible terminal 121, an European-destined liquid crystal television of TOSHIBA (Model: 55WL863G) and a Japan-destined terrestrial/BS/CS110° digital high-definition liquid crystal television of SHARP (Model: LC46W9, released February, 2013) are available.

In such a digital television broadcast receiver, if the signal input through the HDMI/MHL compatible terminal 121 conforms to the HDMI standard, the signal is processed according to the HDMI standard for generating an image to be displayed, and if the signal input through the MDMI/MHL compatible terminal 121 conforms to the MHL standard instead of the HDMI standard, the signal is processed according to the MHL standard for generating an image to be displayed.

The digital television broadcast receiver 111 of the present embodiment is described given that the above-mentioned HDMI/MHL compatible terminal 121 is provided therewith.

The control unit 161 is connected to the HDMI/MHL compatible terminal 121 through a communication I/F 169. The control unit 161 receives/transmits the information from/to a DVD recorder, HDD recorder, and smartphone, etc. connected to the HDMI/MHL compatible terminal 121 through the communication I/F 169.

As the communication I/F 169, an HDMI/MHL port processor (Model: Si19381A) of SILICON IMAGE INC., U.S.A. is available, for example. The processor conforms to both HDMI signal and MHL signal and checks whether the signal input therein is in an HDMI signal format or in an MHL signal format. The control unit 161 receives a check result from the processor (communication I/F 169) to find whether the signal input therein is of the HDMI signal format or of the MHL signal format.

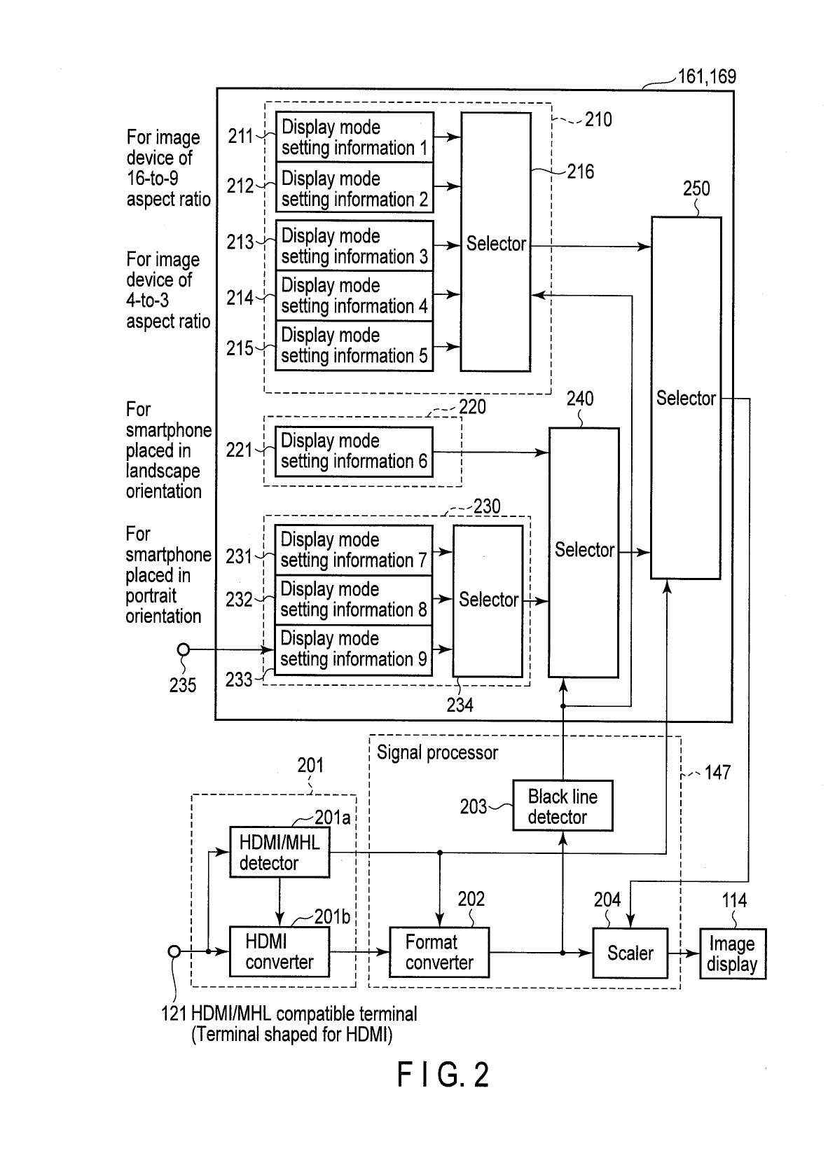

FIG. 2 is a view showing a feature part of the present embodiment. To describe the present embodiment, nine display modes in total are hereinafter exemplified.

Display modes 1 to 5 are designed to display an image output from an image device (such as DVD recorder and HDD recorder).

Display mode 6 is used in a smartphone which is placed in landscape orientation.

Display modes 7 to 9 are used in a smartphone which is placed in portrait orientation.

Here, specific values applied to each display mode are for example purpose only and are not limited to those used in the embodiment.

The HDMI signal or MHL signal supplied to the digital television broadcast receiver 111 through the HDMI/MHL compatible terminal 121 is supplied to an HDMI/MHL detector 201a and an HDMI converter 201b. Reference numeral 201 which is a combination of the HDMI/MHL detector 201a and the HDMI converter 201b in FIG. 2 is the communication I/F 169 in FIG. 1. Both the HDMI/MHL detector 201a and the HDMI converter 201b are functional blocks using the above-explained HDMI/MHL port processor (Model: Si19381A) of SILICON IMAGE INC., U.S.A.

The signal format of HDMI is different from that of MHL, and thus, the difference must be detected. The HDMI/MHL detector 201a detects an HDMI signal or an MHL signal from a signal supplied to the digital television broadcast receiver 111 through the HDMI/MHL compatible terminal 121 and supplies a detection result to a format converter 202 and a selector 250. The HDMI converter 201b converts the signal based on the detection result from the HDMI/MHL detector 201a and supplies the converted signal to the format converter 202. If the signal input in the HDMI/MHL compatible terminal 121 is an HDMI signal, the HDMI converter 201b supplies the HDMI signal as it is to the format converter 202, and if the signal input in the HDMI/MHL compatible terminal 121 is an MHL signal, the HDMI converter 201b converts the MHL signal into an HDMI format and supplies the converted signal to the format converter 202.

As a result of the above, every signal output from the HDMI converter 201b is supplied into the format converter 202 as an HDMI signal. The format converter 202 performs a format conversion process of the HDMI signal from the HDMI/MHL detector 201a according to the HDMI standard to convert the HDMI signal into digital image data and digital audio data. The format converter 202 outputs the acquired digital image data to a black band detector 203 and scaler 204. Note that, since the present embodiment is basically irrelevant to an audio technique, a process of digital audio data shown in FIG. 1 is omitted in FIG. 2.

An image device such as DVD player and the like (image source device) reads extended display identification data (EDID) corresponding to a synch device (image display 114, for example) for receiving an image source from a memory in the synch device, the EDID is a data set storing information concerning functions and performances of the synch device, and outputs an image signal in a format corresponding to the synch device.

Usually, there are three display methods used for displaying an image signal on a 16-to-9 wide screen, they are: a side-panel method (1); top-and-bottom cut method (2); and anamorphic method (3) in general (actually there are other methods available such as intermediate method, etc.). The side-panel method (1) (or may be refereed to as pillar-box method) is to provide an image whose aspect ratio is 4-to-3 in the center of a display screen and adding margins (black margins, in general) on the right and left sides of the image to set the aspect ratio to 16-to-9. That is, the aspect ratio of the original image is maintained. The top-and-bottom cut method (2) is to zoom in on an image whose aspect ratio is 4-to-3 to keep blanks out of the image and cut both top and bottom side of the image to set the aspect ratio to 16-to-9. That is, the aspect ratio of the original image is maintained. The anamorphic method is to expand an image whose aspect ratio is 4-to-3 to set the aspect ratio to 16-to-9. That is, the aspect ratio of the original image itself is altered, and the image is displayed long sideways.

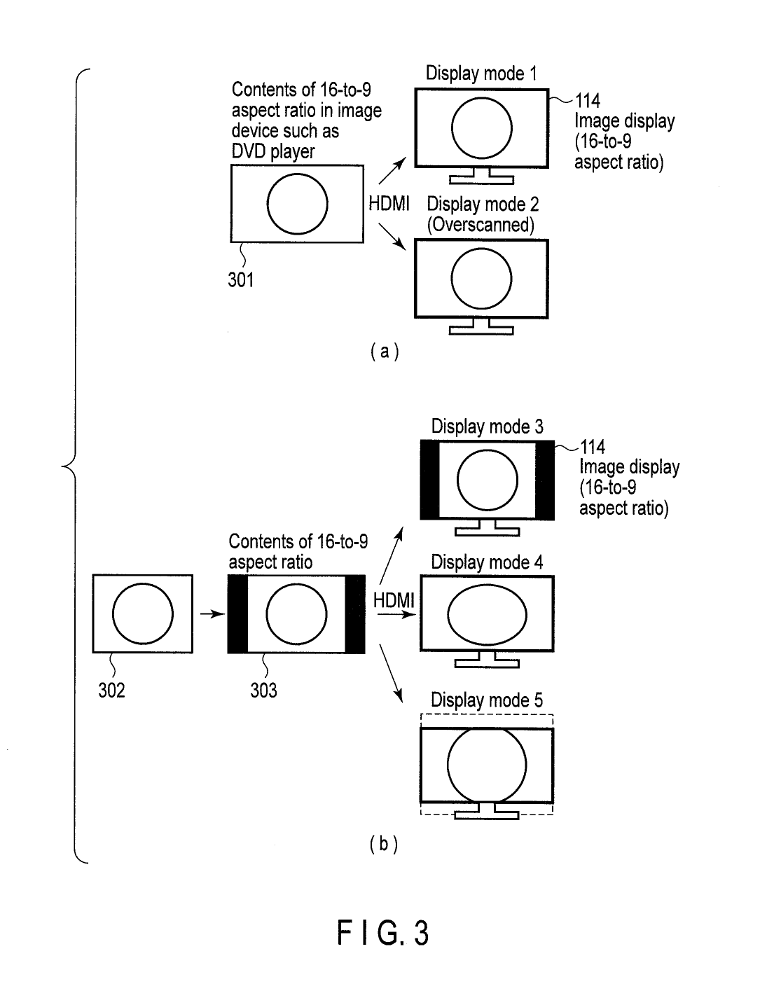

In the present embodiment, as shown in FIG. 3(b), if the image display 114 whose aspect ratio is 16-to-9 is connected to an image device such as DVD player and the like, contents whose aspect ratio is 4-to-3 are converted into contents whose aspect ratio is 16-to-9 by the side-panel method, and the contents are output to the image display 114 through HDMI.

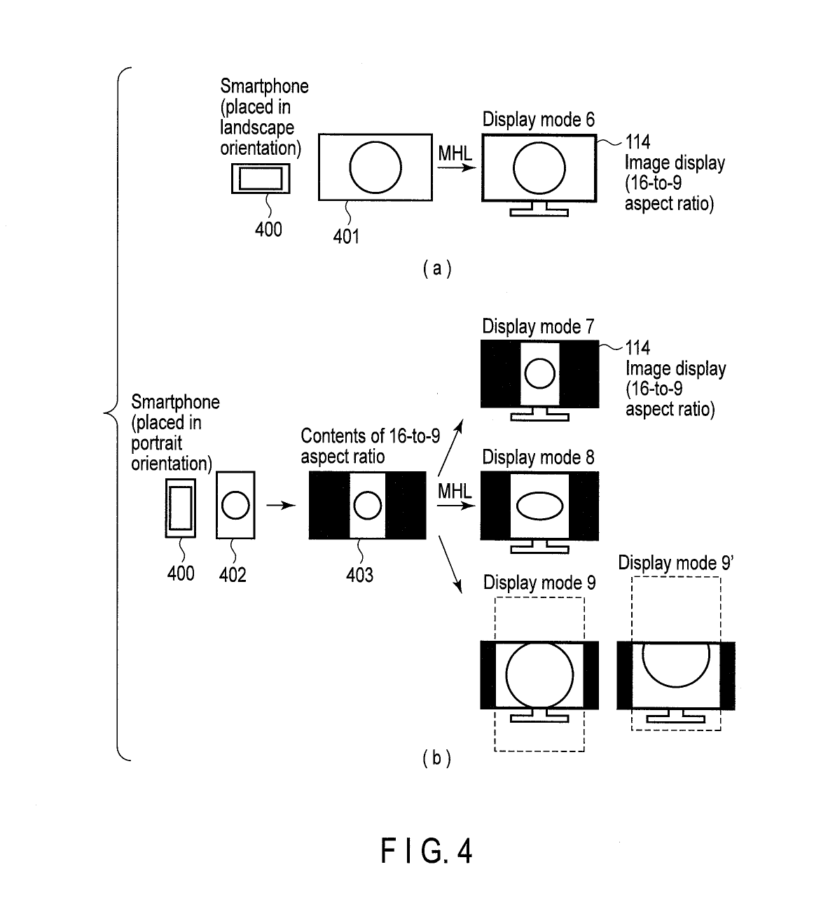

Furthermore, in the present embodiment, as shown in FIG. 4(b), if the image display 114 whose aspect ratio is 16-to-9 is connected to a smartphone, contents whose aspect ratio is portrait 9-to-16 are converted into contents whose aspect ratio is 16-to-9 by the side-panel method, and the contents are output to the image display 114 through MHL.

A black band detector 203 detects black band parts at both sides of digital image data (image data input through HDMI or MHL) input from the format converter 202 as shown in FIG. 3(b) and FIG. 4(b). If there is a black band, a detection result is output to a selector 240. Note that the black band at the side of digital image data may be detected by any conventional technique, and is easily detected by a method of checking whether a black signal is used in certain areas on right and left sides of the digital image data for a certain continuous period of time.

The format converter 202, black band detector 203, and scaler 204 are functional blocks of, for example, the signal processor 147 shown in FIG. 1.

In a first table 210 storing display mode setting information for the display modes designed for the image device (such as DVD recorder and HDD recorder), five display mode setting information items 211 to 215 are stored in this embodiment, for example. The display mode setting information items 211 to 215 are actually stored in a non-volatile memory.

FIG. 3(a) and FIG. 3(b) show display images of each display mode.

The display mode 1 displays contents 301 whose aspect ratio is 16-to-9 from the image device (such as DVD recorder and HDD recorder) to fill the screen without overscanning. The display mode setting information item 211 in the first table 210 is used for the display mode 1. The display mode setting information item 211 is supplied to the selector 216.

The display mode 2 displays contents 301 whose aspect ratio is 16-to-9 from the image device (such as DVD recorder and HDD recorder) to fill the screen with slight enlargement of the image in both horizontal and vertical orientations and overscanning. The display mode setting information item 212 in the table 210 is used for the display mode 2. The display mode setting information 212 is supplied to the selector 216.

To generate the display modes 3, 4, and 5, contents 302 whose aspect ratio is 4-to-3 are firstly converted into contents 303 whose aspect ratio is 16-to-9. The conversion is performed by the image device (such as DVD recorder and HDD recorder) which is a synch device to conform to the aspect ratio (16-to-9) of the image display 114. In this embodiment, the conversion is exemplified by being performed based on the side-panel method (pillar box method) as set by the DVD player.

The display mode 3 displays the contents 302 whose aspect ratio is 4-to-3 from the image device (such as DVD recorder and HDD recorder) with image reduction in horizontal direction and slight image enlargement in vertical orientation and overscanning the form of 4-to-3 aspect ratio into the screen of 16-to-9 aspect ratio. The display mode setting information 213 in the table 210 is used for the display mode 3. The display mode setting information 213 is supplied to the selector 216. In the display mode 3, black blank parts (side panels) are added to both right and left sides of the contents.

The display mode 4 displays the contents 302 whose aspect ratio is 4-to-3 from the image device (such as DVD recorder and HDD recorder) with slight enlargement of the image in both horizontal and vertical orientations and overscanning to fill the screen of 16-to-9 aspect ratio. The display mode setting information 214 in the table 210 is used for the display mode 4. The display mode setting information 214 is supplied to the selector 216.

The display mode 5 displays the contents 302 whose aspect ratio is 4-to-3 from the image device (such as DVD recorder and HDD recorder) with cutting off the black bands on top and bottom of the image and focusing only the central part of the image in the vertical direction in the form of 16-to-9 aspect ratio. The display mode setting information 215 in the table 210 is used for the display mode 5. The display mode setting information 215 is supplied to the selector 216.

The display modes 1 to 5 described above are designed given that the contents output from the image device (such as DVD recorder and HDD recorder) have 16-to-9 or 4-to-3 aspect ratio.

If the black band detector 203 detects no black band on side panels, the selector 216 selects the display mode setting information 211 in the first table 210 as the contents of 16-to-9 aspect ratio and outputs the display mode setting information to the selector 250.

Otherwise, if the black band detector detects black bands at side panels, the selector 216 selects the display mode setting information 213 in the first table 210 as the contents of 4-to-3 aspect ratio and outputs the display mode setting information to the selector 250.

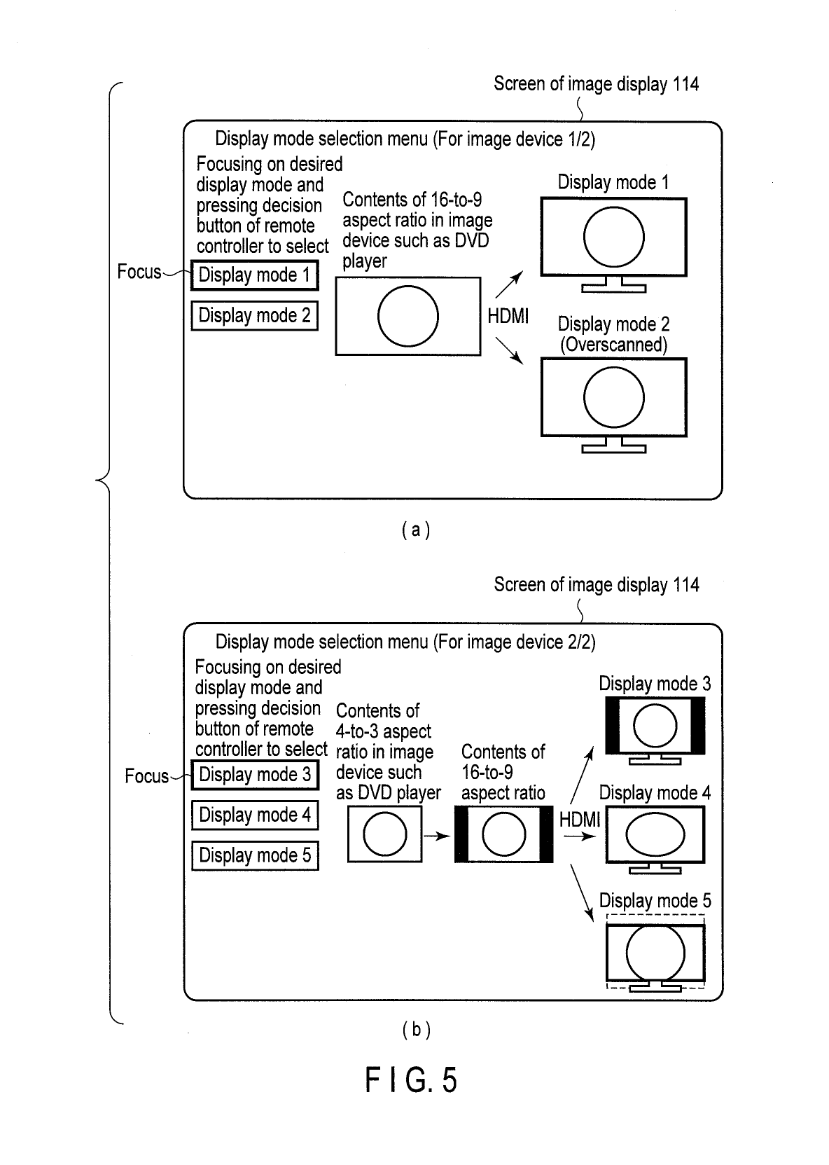

FIG. 5(a) shows an example of setting menu by which a user determines how the contents of 16-to-9 aspect ratio output from the image device (such as DVD recorder and HDD recorder) are displayed. As shown in FIG. 5(a), the user in advance calls the setting menu, focuses on the display mode 1 based on the user's preference, for example, and presses a decision button of the remote controller. Setting of display mode 1 is memorized in the non-volatile memory in the selector 216. To support the user operation, messages explaining operation and display patterns may be indicated in the menu screen.

The selector 216 selects the display setting information 211 and outputs the information to the selector 250.

FIG. 5(b) shows an example of setting menu by which a user determines how the contents of 4-to-3 aspect ratio output from the image device (such as DVD recorder and HDD recorder) are displayed. As shown in FIG. 5(b), the user in advance calls the setting menu, focuses on the display mode 3 based on the user's preference, for example, and presses a decision button of the remote controller. Setting of display mode 3 is memorized in the non-volatile memory and the like in the selector 216. To support the user operation, messages explaining operation and display patterns may be indicated in the menu screen.

The selector 216 selects the display setting information 213 and outputs the information to the selector 250.

If the aspect ratio informed from the image device (such as DVD recorder and HDD recorder) is 16-to-9, the selector 216 selects the display mode setting information of the display mode set in FIG. 5(a) (that is, the display mode setting information 211 corresponding to display mode 1 in the above example) and outputs the selected display mode setting information to the selector 250, and if the aspect ration informed from the image device is 4-to-3, the selector 216 selects the display mode setting information of the display mode set in FIG. 5(b) (that is, the display mode setting information 213 corresponding to display mode 3) and outputs the selected display setting information to the selector 250.

Display mode setting information for a display mode designed for a case where a smartphone is placed in landscape orientation is stored in a second table 220, and in this embodiment, display mode setting information 221 alone is stored therein, for example. The display mode setting information 221 is actually stored in a non-volatile memory. FIG. 4(a) shows display images of this display mode.

The display mode 6 corresponds to the display mode 1 and displays a landscape image 401 whose aspect ratio is 16-to-9 output from a smartphone 400 placed in landscape orientation without overscanning. The display mode setting information 221 in the second table 220 is used for the display mode 6. The display mode setting information 221 is actually stored in the non-volatile memory. The display mode setting information 221 is supplied to a selector 240. Note that although only one display mode is described in this embodiment, a plurality of display modes may be adopted if need be. In that case, selectors including new display mode setting information and used to determine a display mode are additionally provided.

Display mode setting information for display modes designed for a case where the smartphone 400 is placed in portrait orientation is stored in a third table 230, and in this embodiment, three display mode setting information items 231 to 233 are stored therein, for example. The display mode setting information items 231 to 233 are actually stored in a non-volatile memory. FIG. 4(b) shows display images of each display mode. In the portrait orientation, image contents 402 photographed thereby are a portrait image having 9-to-16 aspect ratio; however, the contents eventually output from the smartphone are converted in the smartphone to be a landscape image having 16-to-9 aspect ratio as in the case of landscape orientation. The portrait image of the smartphone is inserted in the center of the screen and side panels are added on both right and left sides of the screen (as in 403 in FIG. 4(b)). The smartphone 400 may have a function to convert the portrait contents 402 into contents 403 to fit the 16-to-9 aspect ratio of the image display 114 which is a synch device.

The display mode 7 corresponds to the display modes 1 and 6 and displays the image output from the smartphone placed in portrait orientation without overscanning. The display mode setting information 231 in the third table 230 is used for the display mode 7. The display mode setting information 231 is supplied to a selector 234. In the display mode 7, the side panels on both right and left sides of the screen are entirely shown as they are input. Thus, the image of the smartphone occupies a small limited area of the image display 114 and this may be a demerit; however, the entire data displayed on the smartphone screen can be displayed on the screen without any distortion.

The display mode 8 displays the image with only the image enlargement in the horizontal direction. The display mode setting information 232 in the third table 230 is used for the display mode 8. The display mode setting information 232 is supplied to the selector 234. In the display mode 8, the image of the smartphone occupies relatively large area of the image display 114 as compared to the case of display mode 7 and this may be a merit; however, the original image form cannot be maintained and a slight distortion in horizontal orientation occurs and this may be a demerit.

The display mode 9 displays the image with the image enlargement in both horizontal and vertical orientations. The display mode setting information 233 in the third table 230 is used for the display mode 9. The display mode setting information 233 is supplied to the selector 234. Originally, contents supplied from a smartphone placed in portrait orientation have the top-to-bottom height conforming to the top-to-bottom height of the 16-to-9 aspect ratio image. Thus, in the display mode 9, when the image is enlarged in the vertical orientation, the image enlargement is performed by cutting off the top end, or the bottom end, or the both top and bottom ends of image. Thus, when the image contents in landscape orientation are displayed in the smartphone placed in portrait orientation, for example, only the image contents can be displayed on the screen of the digital television broadcast receiver 111. Here, since the position of the image contents to be displayed in the smartphone screen varies depending on vertical orientation setting of application used therein, the display position needs to be set changeable by a manual operation.

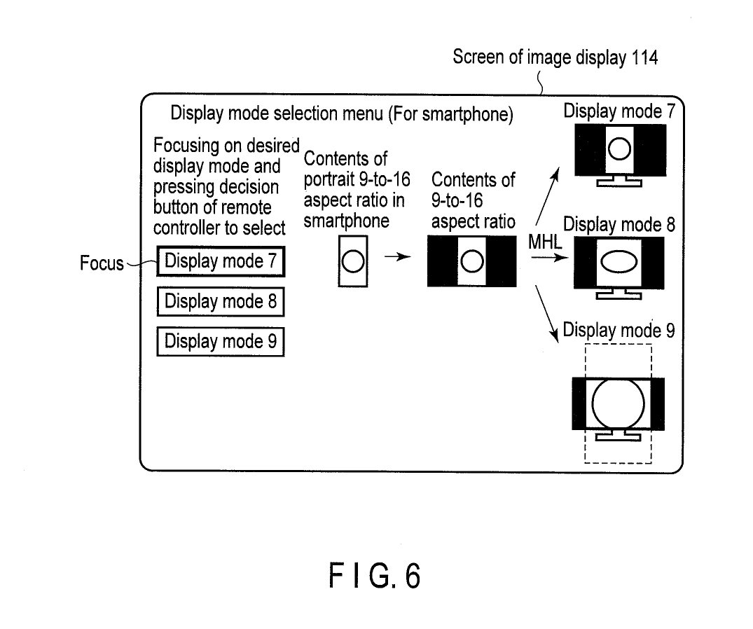

The selector 234 selects the display mode setting information of the display mode set in the setting menu shown in FIG. 6 and outputs the selected display mode setting information to the selector 240 in the same manner as that of FIGS. 5(a) and 5(b). The vertical position information for display mode 9 which is supplied to a terminal 235 is set by a viewer based on the viewer's preference through a menu of the digital television broadcast receiver 111 (not shown).

To use the display mode 9, the vertical position of the image needs to be set. The digital television broadcast receiver 111 receives vertical position changing information from the terminal 235 and, based on the information, changes the display position of the image in the vertical direction as display mode 9′ shown in FIG. 4(b). In the present embodiment, the display position is changed only in the vertical orientation; however, the change is not limited there to and the display position may be changed in the horizontal orientation.

Based on the detection result from the black band detector 203, the selector 240 selects the output from the second table 220 when the result indicates the landscape orientation and the output from the third table 230 when the result indicates the portrait orientation, and outputs the selected display mode information to the selector 250.

Based on the detection result from the HDMI/MHL detector 201a, the selector 250 selects the output from the selector 240 when the result indicates MHL and the output from the first table 210 when the result indicates HDMI, and outputs the selected display mode information to the scaler 204.

Based on the display mode information from the selector 250, the scaler 204 performs scaling treatment on the digital image data from the format converter 202, and the treated image is output to the image display 114.

The image display 114 displays the image from the scaler 204.

Consequently, the image can be displayed in the display mode set in advance based on the user's preference.

In displaying an image, if an HDMI signal is supplied to the HDMI/MHL compatible terminal 121, a display mode designed for an image device (such as DVD recorder and HDD recorder) is selected automatically, and if an MHL signal from a smartphone is supplied to the HDMI/MHL compatible terminal 121, a display mode designed for landscape orientation is selected automatically in a case where the smartphone is placed landscape orientation, and a display mode designed for portrait orientation is selected automatically in a case where the smartphone is placed portrait orientation.

If a smartphone is connected to a TV to display a screen of smartphone thereon, a display mode specifically designed for displaying an image output from an ordinary image device (such as DVD recorder and HDD recorder) does not sufficiently substitute for a display mode for smartphone.

The present invention provides new display modes designed for displaying a screen of smartphone, and furthermore, determines how the smartphone is placed: portrait orientation or landscape orientation to automatically set the display mode to the one desired by a user. Thus, the user can view both the image from the image device (such as DVD recorder and HDD recorder) and the image of smartphone in the desired size without any troublesome operation.

### Another Embodiments

In the above embodiment, the description is presented given that an image of smartphone is displayed in a television receiver through an HDMI/MHL compatible terminal 121.

If a different input terminal is used, an output from image device (such as DVD recorder and HDD recorder) and an output from smartphone cannot be distinguished from one another. In that case, the signal may be designated manually as the output from image device (such as DVD recorder and HDD recorder) or the output from smartphone in a menu of a digital television broadcast receiver 111. Here, if the signal is designated as the output from image device (such as DVD recorder and HDD recorder), a display mode designed for the image device (such as DVD recorder and HDD recorder) is used, and if the signal is designated as the output from smartphone, a display mode designed for smartphone is used while a suitable display mode is selected based on the placement of smartphone: portrait orientation or landscape orientation.

Note that the present invention is not limited to the above-described embodiments and may be realized with modifying structural elements as long as such modification falls within the scope and spirit of the invention. Furthermore, various inventions may be achieved by any arbitrary combination of a plurality of structural elements disclosed in the above embodiments. For example, some structural elements may be deleted from the entire structural elements described in the embodiments. Or, a structural element of one embodiment may be combined with a structural element of the other embodiment. Specifically, the first and second embodiments may be combined together to pair up genre and channel as a desired program attribute.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image signal processing apparatus comprising:
an input terminal to which a first image signal of a first standard and a second image signal of a second standard are compatibly input, the input terminal in accordance with the first standard;
a display mode storage module configured to store a first display mode used when the first image signal is input to the input terminal and a second display mode used when the second image signal is input to the input terminal;
a detection module configured to determine whether the image signal input to the input terminal is of the first image signal or the second image signal; and
an image signal output module configured to generate, if the detection module determines that the first image signal is input to the input terminal, an image signal to be displayed in the first display mode by generating image data using signal processing in accordance with the first standard, and to generate, if the detection module determines that the second image signal is input to the input terminal, an image signal to be displayed in the second display mode by generating image data using signal processing in accordance with the second standard, and the image signal output module configured to output the generated image signal.

2. The image signal processing apparatus of claim 1, further comprising a side panel detection module configured to detect a side panel in the image signal input to the input terminal, wherein
the display mode storage module stores one or more additional first display modes, and
the image signal output module selects one display mode from the plurality of first display modes based on a result from the side panel detection module and generates an image signal to be displayed in the selected display mode.

3. The image signal processing apparatus of claim 1, further comprising a side panel detection module configured to detect a side panel in the image signal input to the input terminal, wherein
the display mode storage module stores one or more additional second display modes, and
the image signal output module selects one display mode from the plurality of second display modes based on a result from the side panel detection module and generates an image signal to be displayed in the selected display mode.

4. The image signal processing apparatus of claim 1, wherein the first standard is HDMI and the second standard is MHL, and the image signal output module determines whether the image signal input to the input terminal is of the HDMI or the MHL.

5. The image signal processing apparatus of claim 1, further comprising:
a GUI generating module configured to generate a GUI to set the first display mode and the second display mode; and
a module configured to have the display mode storage module store a display mode set by a user by operating the GUI generated by the GUI generating module.

6. The image signal processing apparatus of claim 1, further comprising an adjustment module configured to adjust a cutting position in a vertical direction or a horizontal direction based on a predetermined adjustment value to adjust the cutting position in the vertical direction or the horizontal direction.

7. The image signal processing apparatus of claim 1, further comprising a display module configured to display the image signal output from the image signal output module.

8. An image signal processing method using an input terminal to which a first image signal of a first standard and a second image signal of a second standard are compatibly input, the input terminal in accordance with the first standard, and a display mode storage module configured to store a first display mode used when the first image signal is input to the input terminal and a second display mode used when the second image signal is input to the input terminal, the method comprising:
determining whether the image signal input to the input terminal is of the first image signal or the second image signal; and
generating, if the first image signal is determined to be input to the input terminal, an image signal to be displayed in the first display mode by generating image data using signal processing in accordance with the first standard, and generating, if the second image signal is determined to be input to the input terminal, an image signal to be displayed in the second display mode by generating image data using signal processing in accordance with the second standard, and outputting the generated image signal.
